(19) United States
(12) Patent Application Publication
(10) Pub. No.: US 2026/0159652 A1
(43) Pub. Date: Jun. 11, 2026

(54) HIGHLY FILLED POLYMERIC PELLETS, METHODS, AND SYSTEMS FOR CONVERTING FILLER POWDERS AND FIBER FILLERS INTO THE SAME

(71) Applicant: ENTEK Manufacturing LLC, Lebanon, OR (US)

(72) Inventors: Dean Justin Elliott, Albany, OR (US); Austin Stephen Lindsey, Foster, OR (US); Micah Paul Woody, Northeast Salem, OR (US); Megan Rachelle Dyer, Lebanon, OR (US); Jeff Wade Lowe, Slayton, OR (US)

(21) Appl. No.: 19/125,591

(22) PCT Filed: Oct. 18, 2023
(86) PCT No.: PCT/US2023/077213

§ 371 Date: Apr. 29, 2025

Related U.S. Application Data
(60) Provisional application No. 63/382,017, filed on Nov. 2, 2022.

(51) Int. Cl. C08J 3/20; C08J 5/04; C08K 11/00; C08L 97/00

(52) U.S. Cl. CPC C08J 3/201; C08J 5/045; C08K 11/00; C08L 97/005; C08J 2323/06; C08J 2397/00; C08J 2423/06; C08L 2205/16

(57) ABSTRACT

An example method to convert filler powder or fibre filler into a highly filled polymeric concentrate includes providing at least one polymer into a barrel at a first location. The polymer may then be heated to a temperature that is greater than the melting temperature and/or glass transition temperature of the polymer (e.g., a temperature about 5° C. or greater than the melting temperature 2024/097535 and/or glass transition temperature). After heating the polymer, at least one filler may be introduced into the barrel at a second location. The filler is then mixed with the polymer to form a mixture. The method may include dispensing the mixture from the barrel. The dispensed mixture is a highly filled polymeric concentrate because the filler may form about 70 weight percent (“wt %”) or more of the mixture. Using a pellet mill, the highly filled polymeric concentrate can be converted into highly filled polymeric pellets.

### RELATED APPLICATIONS

This application claims priority to U.S. Provisional Patent Application No. 63/382,017 , filed Nov. 2, 2022, and titled Highly Filled Polymeric Pellets, Methods, and Systems for Converting Filler Powders and Fiber Fillers into the Same, which is incorporated herein by reference in its entirety.

### TECHNICAL FIELD

The present disclosure relates to systems and methods for converting filler powders and fiber fillers into highly filled polymeric pellets.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a schematic illustration of a system to convert filler powders and fiber fillers into highly filled polymeric pellets using the methods disclosed herein, according to an embodiment.

FIG. 2 is a flow chart of an example method of using a system disclosed herein, according to an embodiment.

FIG. 3 illustrates a table of parameters utilized by a working example extruder in accordance with the present disclosure.

### DETAILED DESCRIPTION

Embodiments are directed to methods of converting filler powders and fiber fillers (collectively, “fillers”) into highly filled polymeric pellets and systems for making the same. An example method to convert the fillers into the highly filled polymeric pellets includes providing at least one polymer into a barrel at a first location. The polymer may then be heated to a temperature that is greater than the melting temperature and/or glass transition temperature of the polymer (e.g., a temperature about 5° C. or greater than the melting temperature and/or glass transition temperature of the polymer). After heating the polymer, the at least one filler may be introduced into the barrel at a second location. The filler is then mixed with the polymer to form a mixture. The method may then include dispensing the mixture from the barrel. The mixture dispensed from the barrel is a highly filled polymeric concentrate because the filler may form about 70 weight percent (“wt %”) or more of the mixture. The highly filled polymeric concentrate can then be converted into highly filled polymeric pellets.

The methods for converting the fillers into the highly filled polymeric pellets disclosed herein are improvements over conventional methods for pelletizing fillers and forming filled polymeric concentrates. Most methods for pelletizing fillers mixed with polymers and forming filled polymeric concentrates using extruders result in filled polymeric concentrates having less than 65% filler. For example, using such conventional methods, increasing the concentration of fillers in the filled polymeric concentrates above 65% results in a high likelihood (i.e., near certainty) that the extruder die will quickly become clogged at high pressures. However, the methods disclosed do not exhibit these problems associated with conventional methods for forming filled polymeric concentrates and/or pellets. For example, in the methods disclosed herein, the polymer is heated to a high temperature before mixing the polymer with the filler, the die is removed from the exit of the extruder, and the mixture is dispensed into a pellet mill to form a plurality of pellets. The high temperature of the polymer facilitates the mixing dispersion and distribution of the polymer with the high quantity of filler to promote pellet formation in the pellet mill.

It is noted that there are some conventional methods for pelletizing fillers mixed with polymers and forming highly filled polymeric concentrated pellets (i.e., filled polymeric concentrates including a filler concentration of about 70 wt % or greater). However, the methods disclosed herein are also an improvement over such conventional methods. In an example, a conventional method for pelletizing fillers mixed with polymers and forming highly filled polymeric concentrates includes mixing in a liquid polymer dispersion (e.g., the polymer dispersed in a liquid carrier). In such an example, the liquid carrier needs to be removed from the mixture to form the highly filled polymeric concentrate thereby increasing the complexity of the conventional method and adding cost. However, the methods disclosed herein are able to convert fillers into highly filled polymeric concentrated pellets without the use of liquid polymer dispersions. In another example, a conventional method for pelletizing fillers mixed with polymers and forming highly filled polymeric concentrates requires the filler to be chemical wood pulp fiber (i.e., wood pulp fiber is bleached so that the lignin is removed therefrom). However, the methods disclosed herein may include any suitable filler. In some embodiments, the methods disclosed herein include any suitable filler excluding bleached wood pulp fiber with the lignin removed.

Use of the methods disclosed herein are advantageous in many ways. For instance, filler powders and/or fiber fillers that are typically dusty, fluffy, low bulk density, combustible when airborne, cancer causing when inhaled, messy, and/or dirty can be converted into clean, manageable, and/or high density pellets that are easier and/or safer to handle. The high density pellets can also be easier to package and/or ship, increasing manufacturing and transportation efficiencies.

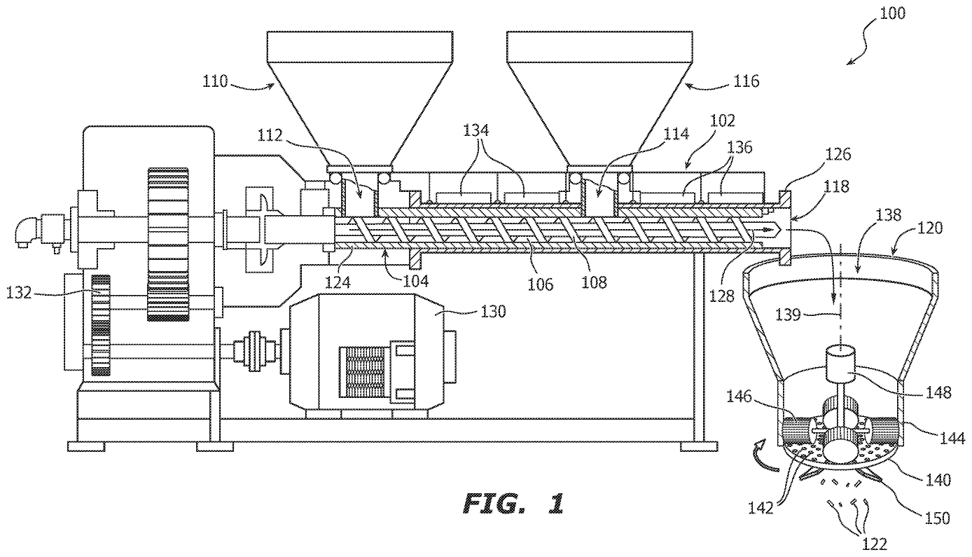

FIG. 1 is a schematic illustration of a system 100 to convert fillers (e.g., filler powders and/or fiber fillers) into a highly filled polymeric concentrate using the methods disclosed herein, according to an embodiment. Briefly and as will be discussed in more detail below, the system 100 includes an extruder 102. The extruder 102 includes a barrel 104 defining a chamber 106 and at least one screw 108 disposed in the chamber 106. The system 100 also includes a polymer source 110 configured to dispense at least one polymer into the chamber 106 at a first location 112. The extruder 102 is configured to heat the polymer in the chamber 106 to a temperature that is greater than the melting temperature and/or glass transition temperature thereof as the polymer moves from the first location 112 to a second location 114 downstream from the first location 112. The system 100 further includes a filler source 116 that is configured to dispense at least one filler into the chamber 106 at the second location 114. The extruder 102 mixes the filler and the polymer together to form a mixture. The extruder 102 moves the mixture from the second location 114 to an outlet 118 of the barrel 104 and dispenses the mixture out of the outlet 118. The mixture dispensed out the outlet 118 may be a highly filled polymeric concentrate. The mixture may then move from the extruder 102 to a pellet mill 120. The pellet mill 120 may then form the mixture into highly filled pellets 122.

The barrel 104 extends between a proximal end 124 and a distal end 126 downstream from the proximal end 124. The distal end 126 of the barrel 104 defines the outlet 118. The chamber 106 extends from a location at or near the proximal end 124 to the distal end 126. The barrel 104 defines at least two openings therein that allow material to enter the chamber 106. For example, the barrel 104 may include a first opening at the first location 112 which allows polymer dispensed from the polymer source 110 to enter the chamber 106 and a second opening at the second location 114 which allows the filler dispensed from the filler source 116 to enter the chamber 106. The first opening may be located at or near the proximal end 124 and the second opening may be located closer to the distal end 126 than the first opening.

At least two screws 108 are disposed in the chamber 106 and extend along at least substantially the entire length of the chamber 106. The screws 108 are configured to at least mix the polymer and the filler together and to move any material disposed in the chamber 106 in a downstream direction 128 (e.g., a direction generally extending from the proximal end 124 to the distal end 126, schematically shown with an arrow). In an embodiment, the extruder 102 is a twin screw extruder. In such an embodiment, the chamber 106 may exhibit a generally 8-like cross-sectional shape and the two screws may collectively exhibit a size and shape that corresponds to the generally-8 like shape. Without limitation, it is believed that the two screws are better able to mix the polymer and filler together at the high concentrations of filler disclosed herein as compared to a single screw extruder. Further, a barrel 104 being configured to have two screws therein may exhibit a wider outlet 118 (e.g., an outlet 118 exhibiting a maximum width of about 20 mm to about 1000 mm, such as about 22 mm to about 900 mm, about 20 mm to about 100 mm or about 40 mm to about 70 mm) than a barrel 104 configured to have only one screw therein, which may facilitate mixing and/or dispensing the mixture from the barrel 104. Examples of a twin extruder that may be used herein are disclosed in U.S. Patent Application Publication No. 2016/0257050 filed on Feb. 5, 2015, the disclosure of which is incorporated herein by reference in its entirety. In an embodiment, more than two screws 108 may be used.

The extruder 102 is configured to rotate the screws 108 relative to the barrel 104 thereby mixing the polymer and filler together and moving any material disposed in the chamber 106 in the downstream direction 128. The extruder 102 may be configured to rotate the screws 108 relative to the barrel 104 using any technique. In an embodiment, as illustrated, the extruder 102 includes a motor 130 (e.g., an electric motor) operably connected to the screw 102 either directly (not shown) or indirectly (e.g., using one or more gears 132, as shown). Other arrangements are also contemplated.

The extruder 102 may include at least one heater 134. The heater 134 may include any suitable heater, such as an electric heater or a fuel burning heater. The heater 134 is configured to heat the polymer in tandem with the frictional (shear) heat generated by the rotating extruder screws between the first location 112 and the second location 114 and, as such, the heater 134 may be located between the first and second locations 112, 114. The heater 134 is configured to heat the polymer (in tandem with the shear heat generated by the rotating screws) such that the polymer exhibits a temperature that is greater than the melting temperature and/or glass transition temperature thereof before the polymer reaches the second location 114. The heater 134 (in tandem with the shear heat generated by the rotating screws) may be configured to heat the portions of the barrel 104 between the first and second locations 112, 114 positioned between the first and second locations 112, 114 to a temperature of about 100° C. or greater, about 125° C. or greater, about 150° C. or greater, about 175° C. or greater, about 200° C. or greater, about 225° C. or greater, about 250° C. or greater, about 275° C. or greater, about 300° C. or greater, about 325° C. or greater, about 350° C. or greater, about 400° C. or greater, about 450° C. or greater, about 500° C. or greater, or in ranges of about 100° C. to about 175° C., about 150° C. to about 200° C., about 175° C. to about 225° C., about 200° C. to about 250° C., about 225° C. to about 275° C., about 250° C. to about 300° C., about 275° C. to about 325° C., about 300° C. to about 350° C., about 325° C. to about 400° C., about 350° C. to about 450°° C., or about 400° C. to about 500° C. It is noted that the polymer may be heated by frictional and/or shear heat generated by rotating the screws in the barrel 102. For instance, in some embodiments, about 10-30% of the thermal energy that heats the polymer can come from the heater 134 and the remainder of the thermal energy that heats the polymer can come from the frictional and/or shear heat generated by the rotating screws.

In an embodiment, the extruder 102 may include at least one additional heater 136 downstream from the second location 114. The additional heater 136 may prevent a decrease in a temperature of the mixture due to heat loss through the barrel 104. The additional heater 136 may also compensate for any decrease in the temperature of the polymer caused by mixing the relatively cool filler into the relatively hot polymer.

As previously discussed, the barrel 104 includes an outlet 118. The outlet 118 may exhibit a size and shape that corresponds to the cross-sectional shape of the chamber 106, such as the chamber 106 of a twin screw extruder. Conventional extruders 102 include a die attached to the outlet 118 of the barrel 104. The die of such conventional extruders 102 may include a plurality of holes extending therethrough with or without wipers configured to form pellets. It has been found that a highly filled concentrate can clog the die. As such, in an embodiment, the outlet 118 of the barrel 104 is not covered by a die to decrease the likelihood that the mixture clogs upon exiting the barrel 104. In another embodiment, the extruder 102 includes a die attached to the outlet 118.

As previously discussed, the system 100 includes a polymer source 110 configured to dispense the polymer into the chamber 106. The polymer source 110 may include any suitable device configured to hold the polymer and dispense the polymer into the chamber 106. In an embodiment, the polymer source 110 may include a hopper that is configured to dispense the polymer at a controlled rate. In an embodiment, the polymer source 110 includes a heater or is otherwise configured to provide a polymer exhibiting a temperature above ambient temperature (i.e., the temperature about the polymer source 110) or room temperature (e.g., about 20° C. to about 30° C.). For example, the polymer source 110 may be configured to heat the polymer to a temperature above the melting temperature and/or glass transition temperature of the polymer and provide a melted polymer to the chamber 106. In an embodiment, the polymer source 110 is directly attached to the first location 112 or is indirectly coupled to the first location 112.

The polymer source 110 may include a variety of polymers. For example, the polymer source 110 may include at least one of acrylic polymers, acrylonitrile butadiene styrenes, alkyds, cellulose butyrates, epoxies, ethylene-carbon monoxides, fluoropolymers, liquid crystal polymers, melamines, methyl methacrylates, phenolics, polyacetals, polylactic acids, polyacrylates, polyamides (e.g., nylon), polybenzimidazole, polybutadienes (e.g., high trans polybutadiene and polybutadiene copolymers), polybutylene terephthalates, polycarbonates, polychlorotrifluoroethylene polymers, polyether sulfones, polyether ether ketones, polyetherimides, polyesters, polyester imides, polyethylenes (e.g., high density polyethylene, low density polyethylene, linear low density polyethylene, etc.), polyhydroxyalkanoate (PHA), polyhydroxybutyrate (PHB), polymethacrylates, polyolefins, polyolefin copolymers (e.g., ethylene-butene, ethylene-octene, ethylene vinyl alcohol, etc.), functionalized polyolefin polymers (e.g., polyethylene grafted maleic anhydride) and copolymers (e.g., polyolefin-based ionmers), polyoxymethylenes, polyphenylene oxides, polyphenylene sulfides, polypropylenes, polysulfones, polystyrenes, polystyrene copolymers (e.g., high impact polystyrene, acrylonitrile butadiene styrene copolymer, styrene/acrylonitirile, styrene/maleic anhydride thermoplastic polymers, etc.), polytetrafluoroethylenes, polytrimethylterephthalates, polyurethanes, polyvinyl chlorides, polyvinylidene fluorides, protein-based polymers, starch-based polymers, styrene-isoprene-rubbers, styrenic block copolymers, sulfopolyesters, ureas, vinyl esters, other thermoplastics, copolymers of any of the foregoing, or combinations of any of the foregoing.

The polymer may be selected for a variety of reasons. In an example, the polymer may be selected based on the application or desired use of the pellets formed by the system 100. For instance, the polymer may be selected to be a polymer that may be burned relatively economically, healthy, and/or in environmentally friendly manner if the pellets 122 are to be burned. In another instance, the polymer may be selected to form a weather proof barrier (e.g., at least one of waterproof, UV resistance, or mold resistance barrier) when the pellets are used to form a composite decking material. The polymer may also be selected based on the maximum operating temperature of the extruder 102 since the polymer needs to be selected to have a melting temperature and/or glass transition temperature that is less than the maximum operating temperature of the extruder 102. In an example, the polymer is selected based on the viscosity of the polymer at a certain temperature. In an example, the polymer of the polymer source 110 is selected to be compatible with the filler and will function best to bind the filler together. A polymer may also be selected to be a best match to the polymer used in the finished product so as to not deteriorate the physical properties and visible appearance of the end product

In an embodiment, the polymer is selected to not include a liquid carrier. In other words, the polymer is not a liquid polymer dispersion. Some conventional methods for converting fillers into highly filled polymeric concentrates use liquid polymer dispersions to adequately disperse the polymer throughout the large quantities of filler. However, the system 100 and the methods disclosed herein may form a mixture without using a liquid polymer dispersion. It is further noted that a polymer that does not include a liquid carrier facilitates pelletizing the fillers and forming the highly filled polymeric concentrates. For example, a polymer that does not include a liquid carrier decreases the moisture content of the highly filled polymeric concentrates (e.g., the pellets 122) which prevents molding and rotting of the highly filled polymeric concentrates. Also, using a polymer that does not include a liquid carrier may simplify the manufacturing process since the highly filled polymeric concentrates may not need drying and a gasified liquid carrier (e.g., steam) does not need to be removed from the extruder. This significantly increases output rates and reduces cost in comparison to using a polymer that includes a liquid carrier to manufacture. In another embodiment, the polymer includes a liquid carrier. Examples of polymers that include liquid carriers are disclosed in U.S. Pat. No. 10,808,109 issued on Oct. 20, 2020, the disclosure of which is incorporated herein, in its entirety, by this reference.

In an embodiment, the system 100 includes a single polymer source 110 that is configured to provide a single polymer or a plurality of polymers (e.g., a mixture of polymers) to the barrel 104. In an embodiment, the system 100 includes a plurality of polymer sources 110 that are distinct from each other. Each of the polymer sources 110 may provide the same polymer(s) or different polymer(s) to the barrel 104. In an example, the plurality of polymer sources 110 may dispense the polymer(s) to the barrel 104 at the first location 112. In an example, the plurality of polymer sources 110 may dispense the polymer(s) at different locations. In such an example, at least one of the polymer sources 110 may provide the polymer(s) at the first location 112 and at least one other polymer source 110 may provide the polymer(s) at an additional location downstream of the first location 112 (e.g., between the first and second locations 110, 112). Providing the polymer(s) at different locations may allow harder to melt polymers (e.g., polymers exhibiting higher melting temperatures and/or higher specific heats) to be heated longer than an easier to melt polymer.

As previously discussed, the extruder 102 is configured to heat the polymer to a temperature that is greater than the melting temperature and/or glass transition temperature of the polymer before the polymer reaches the second location 114. In some embodiments, the extruder 102 is configured to heat the polymer to a temperature that is significantly greater than the melting temperature and/or glass transition temperature of the polymer. The polymer is heated to a temperature that is greater than the melting temperature and/or glass transition temperature thereof when the polymer is heated to a temperature that is greater than the melting temperature and/or glass transition temperature of the polymer by about 5° C. or more, about 10° C. or more, about 15° C. or more, about 20° C. or more, about 25° C. or more, about 30° C. or more, about 35° C. or more, about 40° C. or more, about 45° C. or more, about 50° C. or more, about 60° C. or more, about 70° C. or more, about 80° C. or more, about 90° C. or more, about 100° C. or more, about 125° C. or more, about 150 ° C. or more, about 175° C. or more, about 200° C. or more, about 225° C. or more, about 250° C. or more, or in ranges of about 5° C. to about 15° C., 10° C. to about 20° C., 15° C. to about 25° C., about 20° C. to about 30° C., about 25° C. to about 35° C., about 30° C. to about 40° C., about 35° C. to about 45° C., about 40° C. to about 50° C., about 45° C. to about 60° C., about 50° C. to about 70° C., about 60° C. to about 80° C., about 70° C. to about 90° C., about 80° C. to about 100° C., about 90° C. to about 125° C., about 100° C. to about 150° C., about 125° C. to about 175° C., about 150° C. to about 200° C., about 175° C. to about 225° C., or about 200° C. to about 250° C. As previously discussed, heating the polymer to a temperature that is greater than a melting temperature and/or glass transition temperature thereof facilitates the mixing dispersion and distribution of the polymer with the high quantity of filler to promote pellet formation in the pellet mill. In other words, the raised temperature of the polymer facilitates distribution of the polymer throughout the quantity of filler to promote pellet formation. If the temperature of the polymer is not elevated sufficiently, the polymer can form large solid chunks when the relatively cold filler is added to the barrel 104 which, in turn, makes it more difficult to mix the polymer throughout the quantity of filler. Heating the polymer to a temperature that is greater than the melting temperature and/or glass transition temperature thereof allows the temperature of the polymer to decrease when the filler is mixed therewith substantially without solidifying polymer and, more importantly, allows the formation of a highly filled polymeric concentrate and/or pellet. Further, smaller quantities of the polymer are needed to bind the pellets in the pellet mill 120 when the temperature of the polymer is sufficiently high. Use of smaller quantities of polymer increases the concentration of the filler in the pellets and can thus decrease the cost needed to form the pellets.

The temperature to which the polymer is heated may be selected based on a number of factors. In an example, the temperature to which the polymer is heated may be selected based on the need to utilize as little polymer as possible to facilitate the formation of the pellets in the pellet mill. In an example, the temperature to which the polymer is heated may be selected to be below a degradation or combustion temperature of the polymer. In an example, the temperature to which the polymer is heated may be selected based on the temperature difference between the filler and the polymer. In an example, the temperature to which the polymer is heated may be selected based on the maximum operating temperature of the extruder 102.

As previously discussed, the system 100 includes a filler source 116 configured to hold the filler and to dispense the filler into the chamber 106. The filler source 116 may include any suitable source of the filler. In an embodiment, the filler source 116 may include a hopper that is configured to dispense the filler at a controlled rate. In an embodiment, the filler source 116 includes a heater or is otherwise configured to provide a filler exhibiting a temperature above ambient or room temperature which may minimize any temperature drop in the polymer caused by mixing the filler into the polymer. In an embodiment, the filler source 116 is directly attached to the second location 114 or is indirectly coupled to the second location 114 (e.g., a conveyor belt or slide may transport the filler from the filler source 116 to the second location 114). In an embodiment, the filler source 116 is a loss-in-weight feeder (e.g., that uses a rotating feed auger) configured to provide the filler in a metered and/or ratioed manner.

The filler source 116 may include a variety of fillers, such as inorganic fillers or organic fillers. For example, the filler may include at least one of alumina, ash (e.g., volcanic ash or expanded volcanic ash), barley, biochar, carbonates, carbon black, carbon fibers, carbon nanotubes, cardboard, cenospheres, cellulose, chemical wood pulps (e.g., bleached or unbleached chemical wood pulp, or Kraft chemical wood pulp), clays, cloth fibers, coconut husks, corn, corn husks, corn stalks, cotton, flax, glass fibers, glass microspheres (e.g., solid and/or hollow glass microspheres), other glass particles, graphene, graphite, flax, hemicellulose, hemp, insoluble fibers, jute, kenaf, metal shavings, mica, mulch, newsprint, oats, paper, peanut shells, perlite, pigment (e.g., all colors of pigment), Rayon, rice hulls, sawdust, sesame, silica, silicates, silicon carbide, silicon nitride, sisal, soy hulls, starch, talc, tungsten carbide, wheat, wheat straw, wollastonite, wood fibers, wood flour, wood shavings, other ceramics, other cellulose-containing materials, other grains, other filler material, or combinations thereof. The fillers may be a powder and/or fiber. Pigment powders may be used, including white, black, and any other desired color. When the filler is a powder, the powder may include nanoparticles (e.g., powders exhibiting an average particle size that is less than 1 μm), microparticles (e.g., powders exhibiting an average particle size of 1 μm to 1 mm), milliparticles (e.g., powders exhibiting an average particle size of 1 mm to 10 mm), macroparticles (e.g., powders exhibiting an average particle size greater than 10 mm), or combinations thereof. The average particle size of the powder may be dependent on the final product requirements.

In a particular embodiment, a particular filler may include a significant quantity of lignin. That is, lignin may form about 15 weight % (“wt %”) or more of a particular filler, such as about 20 wt % or more, about 25 wt % or more, or about 30 wt % or more of the particular filler. In such an embodiment, the filler does not include chemical wood pulp (e.g., bleached chemical wood pulp, unbleached chemical wood pulp, and/or Kraft wood pulp). Conventional methods for pelletizing fillers and forming highly filled polymeric concentrates included chemical wood pulp because substantially singulated chemical wood pulp may be extruded to form highly filled polymeric concentrates. However, it has been found that the system 100 and the methods disclosed herein convert fillers into highly filled polymeric concentrates without using substantially singulated chemical wood pulp. As such, the system 100 and the methods disclosed herein may be used to convert filler powders to form highly filled polymeric concentrates using materials other than chemical wood pulps thereby allowing the resulting highly filled polymeric concentrated pellets to be used in more applications. Further, the system 100 and the methods disclosed herein do not require substantially singulated filler before mixing the filler with the polymer. In an embodiment, the filler may include a chemical wood pulp. Examples of chemical wood pulps are disclosed in U.S. Pat. No. 8,722,773 issued on May 13, 2014, the disclosure of which is incorporated herein, in its entirety, by this reference.

In an embodiment, the system 100 includes a single filler source 116 that is configured to provide a single filler or a plurality of fillers (e.g., a mixture of fillers) to the barrel 104. In an embodiment, the system 100 includes a plurality of filler sources 116 that are distinct from each other. Each of the filler sources 116 may provide the same filler(s) or different filler(s) to the barrel 104. In an example, the plurality of filler sources 116 may dispense the filler(s) to the barrel 104 at the second location 114. In an example, the plurality of filler sources 116 may dispense the filler(s) at different locations. In such an example, at least one of the filler sources 116 may provide the filler(s) at the second location 114 and at least one other filler sources 116 may provide the filler(s) at an additional location downstream of the second location 114. Providing the filler(s) at different locations may minimize a decrease in a temperature of the polymer since the polymer may be reheated after the initial mixing of the filler into the polymer.

As discussed, some conventional methods of pelletizing powders and forming highly filled polymeric concentrates are unable to include a filler forming 70 wt % or more of the mixture because, using such conventional methods, the mixture clogs the die. However, the system 100 and the methods disclosed herein do not have such limitations. For example, the filler source 116 may be configured to dispense the filler into the chamber 106 at a sufficient rate that the concentration of the filler in the mixture is about 70 wt % or more, about 75 wt % or more, about 80 wt % or more, about 85 wt % or more, about 90 wt % or more, about 95 wt % or more, or in ranges of about 70 wt % to about 80 wt %, about 75 wt % to about 85 wt %, about 80 wt % to about 90 wt %, about 85 wt % to about 95 wt %, or about 90 wt % to about 99 wt %. The system 100 and the methods disclosed herein may form mixtures exhibiting such high concentrations of filler because, in part, the polymer is heated to a temperature that is greater than the melting temperature and/or glass transition temperature thereof and the extruder does not employ a die at the outlet of the barrel 104.

The concentration of the filler in the mixture may be selected based on a number of factors. In an example, the concentration of the filler in the mixture may be selected based on the polymer and temperature of the polymer just upstream from the second location 114 since the maximum concentration of the filler in the mixture may be limited by the polymer and the temperature of the polymer. In an example, the concentration of the filler in the mixture may be selected based on the filler. In an example, the concentration of the filler may be selected based on the application of the highly filled polymeric concentrate including the filler. In an example, the concentration of the filler in the mixture may be selected based on economic considerations, such as the cost of the polymer, the cost of the filler, and/or the cost of shipping and handling the highly filled polymeric concentrate. In an example, the concentration of the filler may also be selected based on the strength, rigidity, quality, and/or integrity of the pellets formed in the pellet mill.

It is noted that the highly filled polymeric concentrate and the pellets 122 formed from the mixture may exhibit a concentration of filler that is equal to the concentration of the filler in the mixture or slightly greater than the concentration of the filler in the mixture (e.g., due to losing some of the inherent moisture of the polymer and/or filler). In other words, the concentration of filler in the highly filled polymeric concentrate and the pellets 122 may be about 70 wt % or more, about 75 wt % or more, about 80 wt % or more, about 85 wt % or more, about 90 wt % or more, about 95 wt % or more, or in ranges of about 70 wt % to about 80 wt %, about 75 wt % to about 85 wt %, about 80 wt % to about 90 wt %, about 85 wt % to about 95 wt %, or about 90 wt % to about 99 wt % of the mixture.

It is noted that the system 100 and the methods disclosed herein may also be used to form a mixture, filled polymeric concentrate, and/or pellets 122 having a concentration of filler that is less than 70 wt %, such as about 60 wt % or less, about 50 wt % or less, or 40 wt % or less if desired.

In an embodiment, the system 100 may be configured to add an additive to the mixture. The additives may include antiaging stabilizers, antiblocking agents, antifoaming agents, antimicrobial agents, antioxidants, anti-static additives, binders, biocides, blowing agents, coagulents, colorants, compatibilizers, coupling agents (e.g., silanes, zirconates, titanates, maleic anhydride grafted polymers, functionalized polymers, or other agents that may assist in the interfacial adhesion or other adhesion between the polymer and the filler), dispersants, flame retardants, flavoring, foaming additives, fungicides, heat stabilizers, impact modifiers, light stabilizers, lubricants, nucleating agents, odor modifying agents, oxygen scavengers, plasticizers, processing aids, solvents, surfactants, tackifiers, wetting agents, UV stabilizers, any other suitable additive, or combinations thereof. The additives added to the mixture may be selected to at least one of decrease the viscosity of the polymer, increase compatibility between the polymer and the filler, facilitate mixing of the polymer and filler, improve the properties of the highly filled polymeric concentrate, or for other reasons. The amount of the additives present in the mixture may be selected to be less than 10 wt % (e.g., about 7.5 wt % or less, about 5 wt % or less, or about 2.5 wt % or less) of the mixture.

The additives may be added to the mixture in any suitable manner. In an example, the additives may be added to at least one of the polymer or the filler before the polymer or filler is disposed in the chamber 106. In an example, the system 100 may include an additive source that is distinct from the polymer source 110 and the filler source 116. The additive source is configured to dispense the additive into the chamber 106. The additive source may add the additive into the chamber 106 at the first location 112, at the second location 114, at a location between the first location 112 and the second location 114, or at a location downstream from the second location 114. In an example, the additives may be added to the mixture after dispensing the mixture from the extruder 102 (e.g., while the mixture is in the pellet mill 120). In an example, the additives may be added to the mixture as a powder, agglomerates, granules, fibers, sheets, pellets, or in any other form.

The mixture dispensed from the extruder 102 is a highly filled polymeric concentrate. The mixture dispensed from the extruder 102 may be provided to the pellet mill 120 configured to form the highly filled polymeric concentrate into the pellets 122. In an embodiment, the pellet mill 120 may be spaced from the extruder 102. In an example, as illustrated, the pellet mill 120 may be positioned below the outlet 118 with an inlet 138 positioned within the path of the mixture being dispensed from the outlet 118 (e.g., the inlet 138 is positioned directly below the outlet 118). The inlet 138 may be funnel shaped to increase the likelihood that the inlet 138 receives the mixture. In an example, the pellet mill 120 is laterally offset from the outlet 118 of the extruder 102 or otherwise position such that the pellet mill 120 cannot simply receive the mixture dispensed from the outlet 118. In such an example, the system 100 may include a conveyor (e.g., conveyor belt, slide, or auger) that transports the mixture from the outlet 118 of the extruder 102 to the inlet 138 of the pellet mill 120. In an embodiment, the pellet mill 120 is directly attached to the outlet 118 such that the mixture dispensed from the outlet 118 immediately enters the pellet mill 120.

The pellet mill 120 is configured to receive the mixture dispensed from the outlet 118 and form the mixture into pellet 122. The pellet mill 120 may include any suitable pellet mill, such as a Colorado Mill Equipment Pellet Mill. In an embodiment, as illustrated, the pellet mill 120 includes a die 140 having a plurality of openings 142. The openings 142 may be arranged circumferentially about an axis 139. In an example, as shown, the die 140 may include the openings 142 arranged on a planar, circular plate. In an example, not shown, the die 140 may include the openings 142 arranged on a cylindrical plate. The pellet mill 120 may include a wall 144 extending from the die 140 that is configured to prevent the mixture from falling off the edges of the die 140. The pellet mill 120 further includes one or more presses 146. The presses 146 are configured to move (e.g., roll) circumferentially about the axis 139 and press the mixture through the openings 142. For examples, the presses 146 may include rollers configured to roll circumferentially about the axis 139 thereby pressing any mixture that falls between the die 140 and the rollers through the openings 142.

The pellet mill 120 may include at least one wiper 150 on an opposite side of the die 120 than the presses 146. The wiper 150 may rotate about the axis 139 and cut the mixture dispensed through the die 140. The wiper 150 may form pellets 122 exhibiting a substantially uniform length.

The pellet mill 120 may include a motor 148 configured to move the one or more presses 148 relative to the die 140. The motor 148 may also rotate the wiper 150 simultaneously with moving the presses 148.

The pellet mill 120 may include one or more components other than what is illustrated in FIG. 1. In an example, the pellet mill 120 may include a hopper. The mixture received by the pellet mill 120 may be initially stored in the hopper and the hopper may control the rate at which the mixture is provided to the die 140. The hopper may also provide a location for the mixture to cool before the mixture is formed into the pellets 122. In an example, the pellet mill 120 may include a feeder (e.g., rotating screw) that regulates the flow of the mixture to the die instead of or in conjunction with the hopper. The feeder may also provide a location for the mixture to cool before the mixture is formed into the pellets 122. In an example, the pellet mill 120 may include a conditioner that mixes steam with the mixture to soften and lubricate the mixture. In an example, the pellet mill 120 may include an agitator configured to break any clumps of the mixture into smaller pieces. It is noted that any of the above features may be omitted from the pellet mill 120.

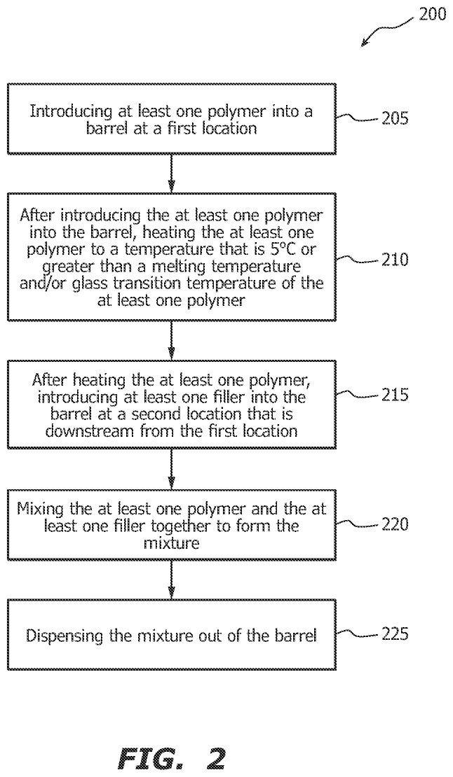

FIG. 2 is a flow chart of an example method 200 of using the system 100, according to an embodiment. The method 200 may include block 205, which recites “introducing at least one polymer into a barrel at a first location.” After block 205, the method 200 may include block 210, which recites “after introducing the at least one polymer into the barrel, heating the at least one polymer to a temperature that is 5° C. or greater than a melting temperature and/or glass transition temperature of the at least one polymer.” After block 210, the method 200 may include block 215, which recites “after heating the at least one polymer, introducing at least one filler into the barrel at a second location that is downstream from the first location.” After block 215, the method 200 may include block 220, which recites “mixing the at least one polymer and the at least one filler together to form a mixture.” After block 220, the method 200 may include block 225, which recites “dispensing the mixture out of the barrel.”

Blocks 205, 210, 215, 220, and 225 are provided for illustrative purposes. One or more of blocks 205, 210, 215, 220, and 225 may be omitted, combined together, supplemented, or otherwise modified. The method 200 may also include one or more additional blocks, such as form the mixture into pellets using a pellet mill after dispensing the mixture out of the barrel. It is further noted that features of the method 200, such as the concentration of the filler in the mixture, the temperature to which the polymer is heated, the structure of the extruder, etc. may be obtained from the description of the system 100.

Block 205 recites “introducing at least one polymer into a barrel at a first location.” For example, block 205 may include dispensing the polymer from the polymer source 110 into the barrel 104 through at least one opening formed in the barrel 104 at the first location 112. The polymer dispensed from the polymer source 110 may include any of the polymers disclosed herein, including mixtures and/or copolymers of any of the polymers disclosed herein. The polymer dispensed from the polymer source 110 may exhibit ambient or room temperature or may have been heated to a temperature that is greater than ambient or room temperature (e.g., to a temperature that is above a glass transition temperature or melting temperature and/or glass transition temperature of the polymer). The polymer dispensed from the polymer source 110 may be solid (e.g., powder, granules, pellets, etc.) or melted.

Block 210 recites “after introducing the at least one polymer into the barrel, heating the at least one polymer to a temperature that is 5° C. or greater than a melting temperature and/or glass transition temperature of the at least one polymer.” For example, after dispensing the polymer into the barrel 104, the screws 108 may move the polymer from the first location 112 towards the second location 114. As the polymer moves, the heater 134 (in tandem with the frictional and/or shear heat generated by the rotating screws 108 inside the barrel 104) heats the polymer. For example, the heater 134 may indirectly heat the polymer by heating the barrel 104 which, in turn transports the thermal energy to the polymer. The heater 134 may provide sufficient thermal energy (e.g., in tandem with the frictional and/or shear heat generated by the rotating screws 108 inside the barrel 104) to the polymer such that the polymer exhibits a temperature that is greater than the melting temperature and/or glass transition temperature of the polymer by the time the polymer reaches the second location 114. For example, the heater 134 (e.g., in tandem with the frictional and/or shear heat generated by the rotating screws 108 inside the barrel 104) may heat the polymer to a temperature that is about 5° C. or greater than the melting temperature and/or glass transition temperature of the polymer, about 20° C. or greater than the melting temperature and/or glass transition temperature of the polymer, or any of the temperatures disclosed herein.

Block 215 recites, “after heating the at least one polymer, introducing at least one filler into the barrel at a second location that is downstream from the first location.” For example, block 215 may include dispensing the filler from the filler source 116 into the barrel 104 through at least one opening formed in the barrel 104 at the second location 114. The filler dispensed from the filler source 116 may include any of the fillers disclose herein, including combinations of any of the fillers disclosed herein. The filler dispensed from the filler source 116 may exhibit ambient or room temperature or may have been previously heated to a temperature that is greater than ambient or room temperature.

Block 220 recites “mixing the at least one polymer and the at least one filler together to form a mixture.” For example, the rotation of the screws 108 and moving the polymer and the filler through the barrel 104 may cause the polymer and the filler to mix together. Mixing the polymer and the filler together may cause a drop in the temperature of the polymer which, in turn, may convert the polymer from a molten liquid phase to a solid phase. However, as previously discussed, heating the polymer to any of the temperatures disclosed herein may allow the polymer to exhibit a temperature and to facilitate formation of concentrated pellets in the pellet mill.

Block 225 recites “dispensing the mixture out of the barrel.” For example, block 225 may include dispensing the mixture out of the outlet 118 of the barrel 104 while the barrel 104 is or is not covered by a die. The mixture dispensed from the barrel 104 is a highly filled polymeric concentrate. In an embodiment, dispensing the mixture out of the barrel 104 includes dispensing the mixture into a pellet mill 120 (e.g., a pellet mill 120 that is below, spaced from, or directly attached to the outlet 118). In such an embodiment, the method 200 may include forming the mixture into pellets 120 using the pellet mill 120. In an embodiment, the mixture dispensed from the barrel 104 is not immediately provided to the pellet mill 120. In such an embodiment, the mixture may be stored and provided to the pellet mill 120 at a later time or the mixture may be shipped to another location (e.g., shipped to a manufacturer to take the pellets and manufactures the pellets into a product). In an embodiment, block 225 includes cooling the mixture dispensed from the barrel 104 before providing the mixture to the pellet mill 120.

The highly filled polymeric concentrates (e.g., pellets) disclosed herein may be used in a variety of applications. For example, the highly filled polymeric concentrates may be used in the automotive industries and in building and construction. In an embodiment, the highly filled polymeric concentrates may be provided to a manufacturer who then uses the pellets to form a product.

### WORKING EXAMPLES

The following working examples provide further detail about the systems and methods disclosed herein in accordance with the principles of some of the specific embodiments disclosed herein.

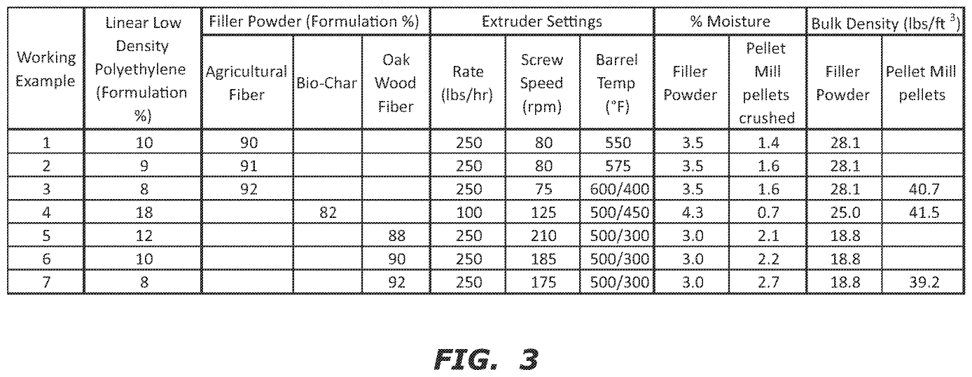

An ENTEK QC 43 mm twin screw extruder 52:1 L/D (“Working Example Extruder”) was used to form Working Examples 1-7. The Working Example Extruder included a Brabender FW40 feeder configured to provide a linear low density polyethylene (20 MFI) to the barrel of the Working Example Extruder at a first location. The Working Example Extruder was configured to heat the linear low density polyethylene to a temperature that was greater than the melting temperature and/or glass transition temperature thereof. The melting point of the linear low density polyethyelene is about 120°C. and Working Examples 1-7 were heated to between 260° C. and 320° C. The Working Example Extruder included a Brabender FW79 feeder configured to provide either agricultural fiber, oak wood fiber or Bio-Char to the barrel of the Working Example Extruder at a second location. The Working Example Extruder had no die. The parameters of the Working Example Extruder used to form Working Examples 1-7 are shown in the table of FIG. 3.

Working Examples 1-7 were formed using the method 200. In particular, the linear low density polyethylene was provided at the first location and heated to a temperature that was greater than the melting temperature and/or glass transition temperature of the linear low density polyethylene before the linear low density polyethylene reached the second location. The filler (oak wood fiber, agricultural fiber or bio-char) was then added to the barrel at the second location and mixed with the linear low density polyethylene. The compositions of the Working Examples 1-7 are provided in FIG. 3. In particular, the amount of linear low density polyethylene added to the barrel at the first location is provided. In particular, the amount of oak wood fiber added to the barrel at the second location is provided. The moisture content of the mixture of some of the Working Examples were measured, as shown in FIG. 3. In particular, it was found that the moisture content of the mixture converted to pellets was less than the filler powders entering the extruder at the second location. It is believed that the mixture would have exhibited a higher moisture content if the mixture was formed using a liquid polymer dispersion.

The mixtures dispensed from the Working Example Extruder was provided to a Pellet Machine MKL229 (“Working Example Pellet Mill”) and then was formed into pellets. The moisture content of the pellets of some of the Working Examples were measured, as shown in FIG. 3. In particular, it was found that the moisture content of the pellets was less than the moisture content of the filler powders entering the extruder at the second feed location. Again, it is believed that the pellets would have exhibited a higher moisture content if the mixture was formed using a liquid polymer dispersion. It is also noted that the bulk density of the filler increased substantially for all three fillers thereby allowing the fillers to be provided in a non-dusty, clean pellet at lower shipping costs.

While various aspects and embodiments have been disclosed herein, other aspects and embodiments are contemplated. The various aspects and embodiments disclosed herein are for purposes of illustration and are not intended to be limiting.

1. A method for converting filler powder or fiber fillers into highly filled polymeric pellets, the method comprising:
introducing at least one polymer into a barrel of an extruder at a first location;
after introducing the at least one polymer into the barrel, heating the at least one polymer to a temperature that is about 5° C. or greater than a melting temperature and/or the glass transition temperature of the at least one polymer;
after heating the at least one polymer, introducing at least one filler into the barrel at a second opening that is downstream from the first opening;
mixing the at least one polymer and the at least one filler together to form a mixture, the at least one filler forming about 70 weight % or more of the mixture; and
dispensing the mixture out of the barrel.

2. The method of claim 1, wherein the at least one polymer is substantially free of a liquid carrier.

3. The method of claim 1, wherein heating the at least one polymer includes heating the at least one polymer to a temperature that is about 20° C. or greater than the melting temperature and/or glass transition temperature of the at least one polymer.

4. The method of claim 3, wherein heating the at least one polymer includes heating the at least one polymer to a temperature that is about 40° C. or greater than the melting temperature and/or glass transition temperature of the at least one polymer.

5. The method of claim 1, wherein the at least one filler includes lignin.

6. The method of claim 1, wherein the at least one filler includes at least one of barley, biochar, corn, flax, oats, sesame, or wheat.

7. The method of claim 1, further comprising, prior to introducing the at least one filler into the barrel, heating the at least one filler to a temperature that is greater than ambient temperature or room temperature.

8. The method of claim 1, wherein the at least one filler forms about 90 weight % or more of the mixture.

9. The method of claim 1, wherein mixing the at least one polymer and the at least one filler together includes mixing the at least one polymer and the at least one filler together in a twin screw extruder.

10. The method of claim 1, wherein dispensing the mixture out of the barrel includes dispensing the mixture out of the barrel without using a die.

11. The method of claim 1, further comprising, after dispensing the mixture out of the barrel, introducing the mixture into a pellet mill and, with the pellet mill, forming the mixture into a plurality of pellets.

12. The method of claim 10, further comprising cooling at least one of the polymer or the mixture after introducing the at least one filler into the barrel.

13. The method of claim 1, further comprising introducing at least one additive into the barrel.

14. The method of claim 1, further comprising heating the mixture downstream from the second location.

15. A highly filled polymeric concentrate comprising:
at least one filler; and
at least one polymer matrix including the at least one filler disposed therein;
wherein the at least one filler is substantially free of chemical wood pulp;
wherein the at least one polymer is substantially free of a liquid carrier; and
wherein the at least one filler forms about 70 weight percent or more of the highly filled polymeric concentrate.

16. The highly filled polymeric concentrate of claim 15, wherein the at least one filler includes lignin.

17. The highly filled polymeric concentrate of claim 15, wherein the at least one highly filled polymeric concentrate is formed into a plurality of pellets.

18. A system to convert filler powder or fiber filler into a highly filled polymeric concentrate, the system comprising:
an extruder including a barrel having a proximal end and a distal end downstream from the proximal end, the barrier defining a chamber and an outlet at or near the distal end;
at least one polymer source configured to hold at least one polymer and dispense the at least one polymer into the chamber at a first location;
at least one filler source configured to hold at least one filler and dispense the at least one filler into the chamber at a second location that is downstream from the first location;
at least one heater configured to heat the barrel at least between the first location and the second location; and
a pellet mill configured to receive a mixture dispensed from the outlet of the extruder.
